(19) United States
(12) Patent Application Publication
(10) Pub. No.: US 2011/0000016 A1
(43) Pub. Date: Jan. 6, 2011

(54) SUPINE LIFT AND STRETCHER

(76) Inventor: Fredrick Shriver, Vista, CA (US)

Correspondence Address: MICHAEL RIES, 318 PARKER PLACE, OSWEGO, IL, 60543, US

(21) Appl. No.: 12/828,688

(22) Filed: Jul. 1, 2010

Related U.S. Application Data
(60) Provisional application No. 61/222,466, filed on Jul. 1, 2009.

(51) Int. Cl. A61G 7/10

(52) U.S. Cl. 5/86.1

(57) ABSTRACT

A lift and stretcher apparatus for a patient includes a base portion at least partially defined by an elongated portion extending generally in a first orthogonal direction and having a first end, a second end, and a central portion interposed there between; a frame having a first lateral portion extending in the first orthogonal direction and defining a first lateral portion distal end and a first lateral portion proximal end, a second lateral portion defining a second lateral portion distal end and a second lateral portion proximal end, a proximal portion, and a distal portion extending generally in a second orthogonal direction; a lifting portion interconnecting the base with the frame for moving the frame relative to the base generally in a third orthogonal direction; a first axle portion having; and a second axle portion.

### CROSS-REFERENCE TO RELATED APPLICATIONS

This application claims priority to U.S. Provisional Application 61/222,466, filed on Jul. 1, 2009; the disclosure of which is incorporated by reference in its entirety.

### TECHNICAL FIELD

The disclosure relates generally to stretchers and lifts for moving and transporting patients.

### BACKGROUND

Many times in a hospital or other care giving facility, a person is transferred from one bed or stretcher to another. Generally, the person is in a supine position. This maneuver may increase the risk that a person is undesirably handled in a manner that may cause injury. Further, more than one person may be required to transfer a person one bed or stretcher to another, thus requiring additional personnel or requiring an undesirable wait until additional personnel are available.

What is needed is a device or apparatus for moving a person in a supine position. A desirable device would permit a minimum number of people for the transfer and reduce the occurrences of inadvertent injury. The device needs to have features that allow it to be easily maneuvered in its role as a transporter yet be capable of fitting around the varied patient surfaces it will encounter as a supine lift.

### SUMMARY

In an embodiment, a stretcher is provided to move a patient. The stretcher is moveable on wheels and provides a mechanism to connect to a sling portion that the patient is positioned on and then lift the patient generally vertically to clear a hospital bed. The device has features that allow it to be easily maneuvered in its role as a transporter yet be capable of fitting around the varied patient surfaces it will encounter as a supine lift.

### BRIEF DESCRIPTION OF THE DRAWINGS

The drawings are illustrative embodiments. The drawings are not necessarily to scale and certain features may be removed, exaggerated, moved, or partially sectioned for clearer illustration. The embodiments illustrated herein are not intended to limit or restrict the claims.

FIG. 1 is perspective view of an apparatus according to an embodiment.

FIG. 2 is a perspective view of an exemplary hospital bed with a sling portion according to an embodiment.

FIG. 3 is a side view of the apparatus of FIG. 1, in a first configuration.

FIG. 4 is a side view of the apparatus of FIG. 1, in a second configuration.

FIG. 5 is a side view of the apparatus of FIG. 1, illustrated in a third configuration.

FIG. 6 is a partial cut-away view of a portion of the apparatus of FIG. 1, illustrated in a third configuration.

### DETAILED DESCRIPTION

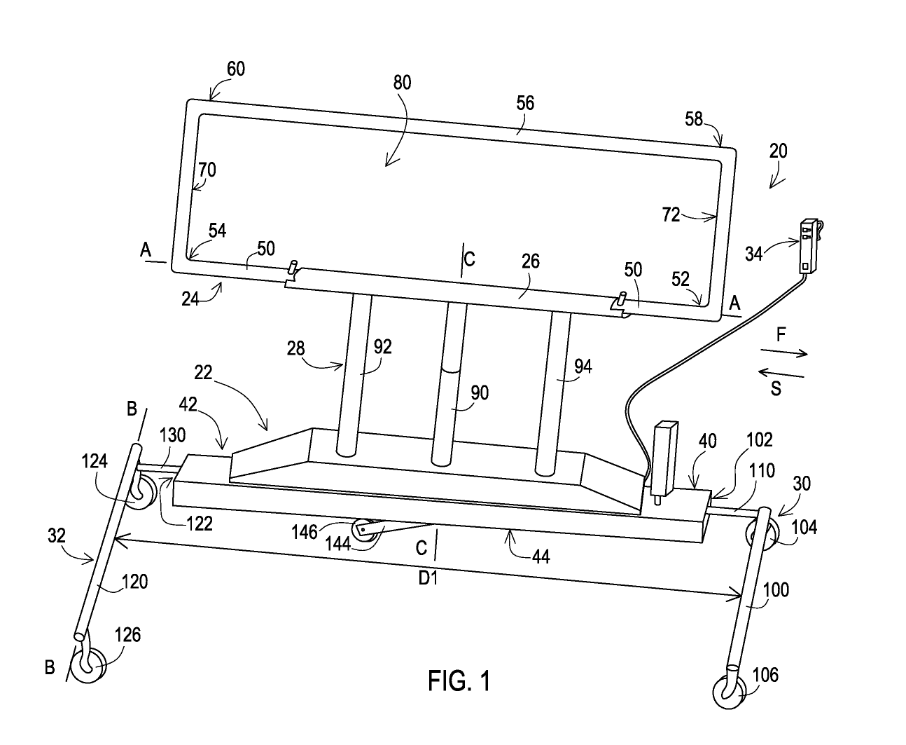

FIG. 1 illustrates an embodiment of an apparatus 20. The apparatus 20 includes a base 22, a frame 24, an upper member 26, a lifting portion 28, a first axle portion 30, a second axle portion 32, and a control 34.

In the embodiment illustrated, the base portion 22 is at least partially defined by an elongated portion extending generally parallel to a first orthogonal axis A-A and having a distal end 40, a proximal end 42, and a central portion 44 interposed therebetween.

The frame 24 includes a first lateral portion 50 extending along the first orthogonal axis A-A and defining a first lateral portion distal end 52, and a first lateral portion proximal end 54, a second lateral portion 56 defining a second lateral portion distal end 58 and a second lateral portion proximal end 60, a proximal portion 70 selectively extending generally parallel to a second orthogonal axis B-B and interconnecting the first lateral portion proximal end 54 and the second lateral portion proximal end 60, and a distal portion 72 extending generally in a second orthogonal direction extending generally parallel to the second orthogonal axis B-B and interconnecting the first lateral portion distal end 52 and the second lateral portion distal end 58. As illustrated, at least two of the first lateral portion 50, the second lateral portion 52, the proximal portion 70, and the distal portion 72 define a frame opening 80. The frame 24 also includes a plurality of buckle portions 82 coupled thereon and spaced apart about the frame opening 80, as discussed in greater detail below.

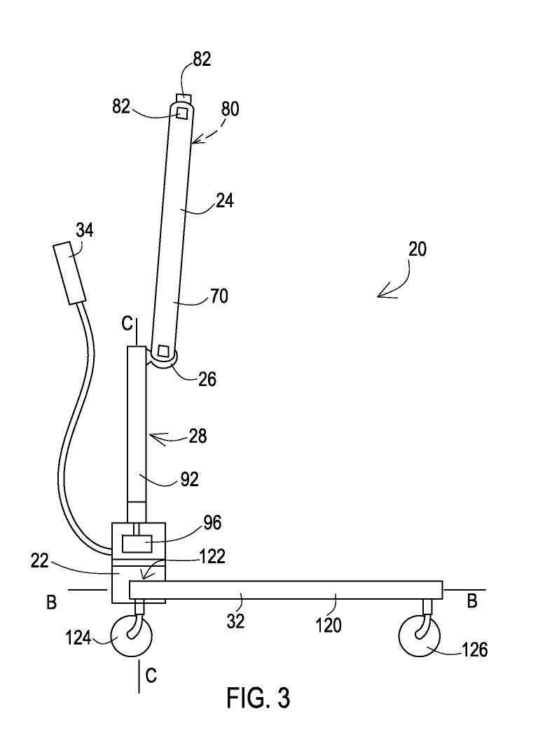

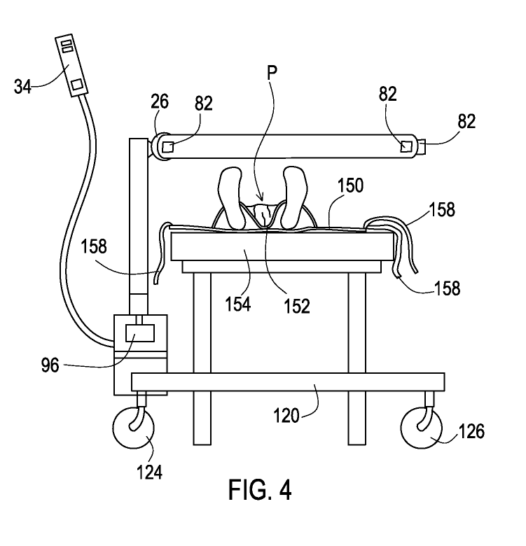

The upper member 26 includes the first lateral portion 50 at least partially interposed therein and rotatable relative thereto, such that the proximal portion 70 and the distal portion 72 will each extend generally in the third orthogonal axis C-C (a first configuration of FIGS. 1 and 3) and then the frame 24 be allowed to rotate about the axis A-A until the proximal portion 70 and the distal portion 72 will each extend generally in the second orthogonal axis B-B (a second configuration of FIG. 4).

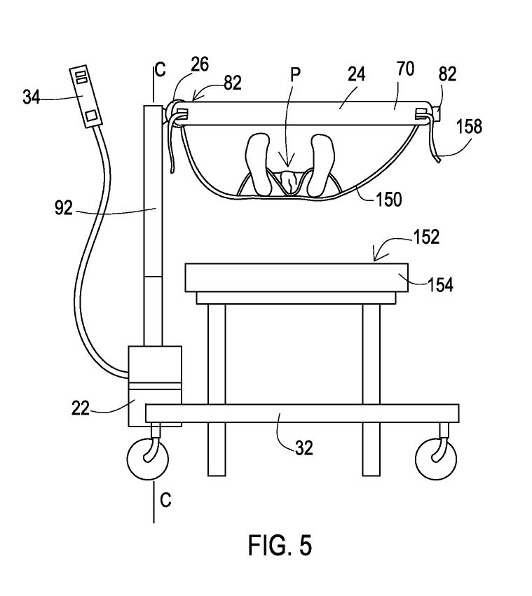

The lifting portion 28 interconnects the base 22 with the frame 24 for moving the frame 24 relative to the base 22 generally parallel to the third orthogonal axis C-C between a lowered position (the second configuration of FIG. 4), and a raised position (a third configuration of FIG. 5). As best seen in FIG. 1, the lifting portion 28 includes a lifting arm 90, a first guide portion 92, and a second guide portion 94. The lifting arm 90 is operatively coupled to a lifting actuator 96 (FIG. 3) that may raise and lower the frame 24 in relation to the base 22. The first guide portion 92 and the second guide portion 94 reduce rotation of the frame 24 relative to the base 22 about the third orthogonal axis C-C.

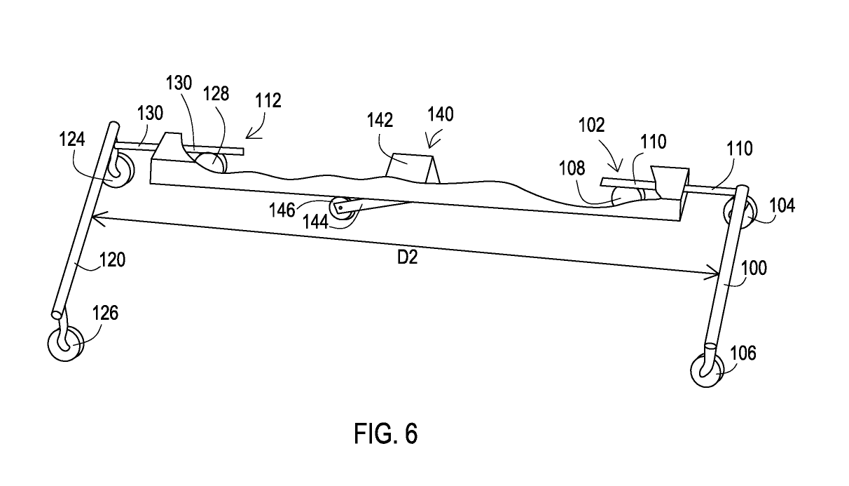

The first axle portion 30 and the second axle portion 32 each include at least one wheel for transportation of the apparatus 20. Specifically, the first axle portion 30 includes an axle 100 extending generally parallel to the axis B-B, a first coupling mechanism 102, a wheel 104, and a wheel 106. The coupling mechanism 102 includes a first driver 108 and a first driven portion 110. The driven portion 110 interconnects the axle 100 with the driver 108 such that the axle 100 may be moved generally parallel to the axis A-A. The second axle portion 32 includes an axle 120 extending generally in the axis B-B, a second coupling mechanism 122, a wheel 124, a wheel 126 a second driver 128, and a second driven portion 130. The driven portion 130 interconnects the axle 120 with the driver 128 such that the axle 120 may be moved generally parallel to the axis A-A. This translation of the axles 100, 120 relative to the base 22 is best illustrated in a comparison between FIG. 1, where a distance between axles 100, 120 (wheelbase) is D1, and FIG. 6, where a distance between axles 100, 120 is D2. As illustrated, distance D2 is greater than distance D1. The capability to move each axle 100, 120 relative to the base 22 may assist in reducing the wheelbase for maneuvering the apparatus 20 through a corridor of a building, or may assist in altering the wheelbase for preventing contact between the first axle portion 30 and the second axle portion 32 and the lower portions of a hospital bed (legs, undercarriage, etc.), such as the exemplary bed 154.

Accordingly, the first axle portion 30 and the second axle portion 32 are coupled to the base 22 and may be moved relative to the base 22 generally parallel to the first orthogonal axis A-A. Importantly, the first axle portion 30 and the second axle portion 32 may be moved relative to the base 22 while a patient is being supported by the apparatus 20. Accordingly, the distance between the axle portions 30, 32 may be reduced to navigate the apparatus through doorways or other obstacles.

As best seen in FIG. 6, the base 22 also includes a covered or uncovered lower control portion 140 including a driver 142, a lower control arm 144 and a lower floor rolling contacting portion 146. In operation, the driver 142 may rotate the arm 144 such that the rolling portion 146 contacts the floor and then exerts a force on the floor. This creates a guide device while transporting.

The control 34 includes a plurality of control actuation portions that may control lifting and lowering the frame 24 generally parallel to the axis C-C and moving the first axle portion 30 and the second axle portion 32 generally parallel to the axis A-A. In an embodiment, the control 34 sends a signal to each of the lifting drier 96, the first driver 108, the second driver 128 and the driver 142 for controlling operation of the apparatus 20.

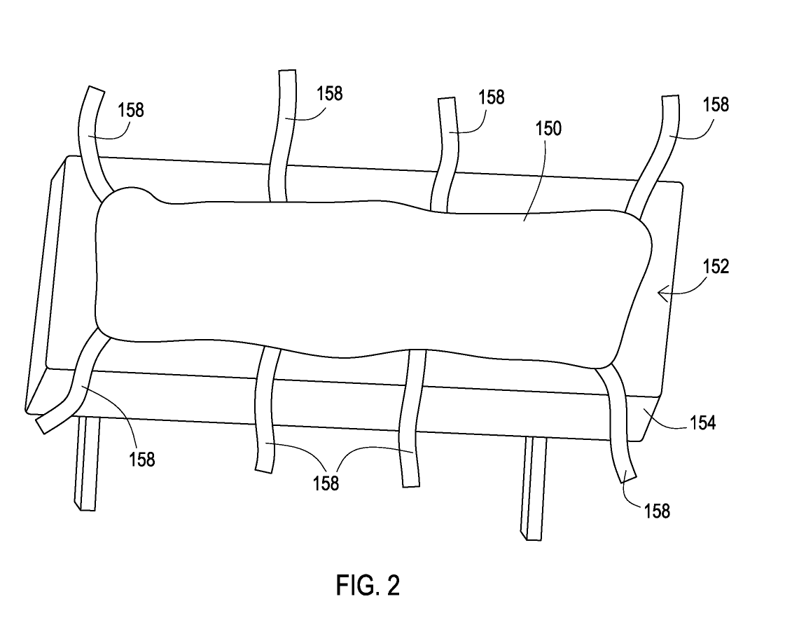

As best seen in FIG. 2, a sling portion 150 may be placed on the upper surface 152 of an exemplary hospital bed or stretcher 154. The sling 150 includes a plurality of straps 158 extending from the periphery of the sling 150 for lifting the sling 150.

In operation. the sling 150 is positioned on a patient support surface, such as the bed 154, generally as shown in FIG. 2. A patient P may then be positioned on the sling 150, as generally depicted in FIG. 4. The apparatus 20 may be in the first configuration of FIGS. 1 and 3 where the proximal portion 70 of the frame 24 extends generally in parallel to the axis C-C or a suitable angle (appropriate) between axis C-C and axis B-B to provide clearance. The axles 100, 120 may then be positioned to avoid contact between the axles 100, 120 and the bed 154. The apparatus 20 may then be positioned relative to the bed 154 (by moving the apparatus 20 generally parallel to the axis B-B) and the frame 24 may be rotated about the axis A-A to the position shown in FIG. 4 such that the frame opening 80 at least partially encircles the patient P. When in the position shown in FIG. 4, the straps 158 may be coupled to the buckles 82 and tightened. Then, the lifting actuator 96 may raise the arm 90 and frame 22 generally in the direction U until the patient P and the sling 150 clear the upper surface 152 of the bed 154. Then, the apparatus 20 and the patient P may be moved to another bed. Before transporting, axles 100, 120 may then be positioned to provide a shorter wheelbase for maneuvering. When one desires to position the patient P on a surface (such as a second bed), the apparatus 20 is maneuvered via the wheels 104, 106, 124, 126 such that the patient P is directly over the surface. The control 34 is then used to send a signal to the driver 90 for lowering the patient P onto the surface. Then, the strap portions 158 are uncoupled from the frame 24. The frame may then be rotated or raised, or both, and the apparatus 20 may be moved away from the patient P.

In the embodiment illustrated, the frame 24 is constructed of tubular steel, although other suitable materials may be used.

Although the steps of the method of using the apparatus 20 may be listed in an order, the steps may be performed in differing orders or combined such that one operation may perform multiple steps. Furthermore, a step or steps may be initiated before another step or steps are completed, or a step or steps may be initiated and completed after initiation and before completion of (during the performance of) other steps.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A supine lift and stretcher apparatus for a patient, comprising:
a base portion at least partially defined by an elongated portion extending generally in a first orthogonal direction and having a first end, a second end, and a central portion interposed there between;
a frame having a first lateral portion extending in the first orthogonal direction and defining a first lateral portion distal end and a first lateral portion proximal end, a second lateral portion defining a second lateral portion distal end and a second lateral portion proximal end, a proximal portion interconnecting the first lateral portion proximal end and the second lateral portion proximal end, and a distal portion extending generally in a second orthogonal direction interconnecting the first lateral portion distal end and the second lateral portion distal end, wherein at least two of the first lateral portion, the second lateral portion, the proximal portion, and the distal portion define a frame opening;
an upper member having the first lateral portion at least partially interposed therein;
a lifting portion interconnecting the base with the upper member for moving the frame relative to the base generally in a third orthogonal direction;
a first axle portion having at least one wheel for transportation of the apparatus; and
a second axle portion having at least one wheel for transportation of the apparatus,
wherein the first axle portion and the second axle portion are coupled to the base.

2. The apparatus of claim 1, wherein the first axle portion and the second axle portion may be moved relative to the base to increase and decrease a wheelbase and can be moved while the apparatus is in use.

3. The apparatus of claim 1, wherein the first axle portion and the second axle portion each include only two wheels.

4. The apparatus of claim 1, further comprising a sling portion having a plurality of strap portions for coupling the sling portion to the frame.

5. The apparatus of claim 1, further comprising a sling portion being selectively coupled to the frame

6. The apparatus of claim 5, wherein the lifting portion will selectively move the frame upward such that a patient in the sling will be raised above a surface.

7. The apparatus of claim 1, wherein the frame is coupled to the lifting portion such that the frame may be rotated generally about an axis parallel to the first orthogonal direction and the lifting portion.

8. The apparatus of claim 1, wherein the upper member is coupled to the first lateral portion such that the frame may be rotated relative to the upper portion.

9. The apparatus of claim 1, further comprising a plurality of buckle portions attached to the frame for attaching a sling to the frame.

10. The apparatus of claim 1, further comprising a control device for raising and lowering the frame and/or moving the first axle portion and the second axle portion relative to the base to increase and decrease a wheelbase.

11. The apparatus of claim 1, further comprising a covered lower control portion including a driver operating a lower control arm and floor rolling contacting portion parallel to base for exerting a force on a floor that the apparatus is supported on for transport guidance

12. The apparatus of claim 1, further comprising a movable guide wheel attached centrally to the base frame parallel to the long axis of the frame using an enclosed hand operated mechanical or electrically actuated device attached to the wheel mount to raise the wheel from floor contact or to force wheel into floor contact with a predetermined force

13. A supine lift and stretcher apparatus for a patient, comprising:
a base with a first supporting leg with at least one wheel and a second supporting leg with at least one wheel coupled orthogonal to a central base segment in such a manner that allow the first leg and/or the second leg to extend from the base to allow wheelbase adjustment wherein the wheelbase adjustment can be made with electronic actuation and/or with a hand operated mechanical device and can be adjusted while the apparatus is in normal use; and
a horizontal patient support surface frame, connected to a the base in such a way as to provide a movable connection that allows the patient surface frame to be lifted vertically by means of electronic actuation or a hand operated mechanical lifting device.

14. A method, comprising:
positioning a patient on a sling portion, wherein the sling portion includes a plurality of strap portions;
adjusting the wheel base of base frame of devise, enlarging as necessary to allow clearance for positioning;
positioning a frame adjacent the sling portion;
rotating the frame defining a frame opening relative to an upper member;
positioning the frame above a patient such that a periphery of the frame opening at least partially encircles the patient;
coupling the strap portions to the frame;
sending a signal to a lifting portion driver for urging the upper member upward such that the frame is moved upward and the patient and sling are raised above the bed; and
wheeling the frame away from a first bed to transport the patient.

15. The method of claim 14, further comprising sending a signal to a driver for automatically adjusting the wheel base of a base supporting the frame while the apparatus is in use.

16. The method of claim 14, further comprising sending a signal to the lifting portion driver for lowering the patient onto a second bed.

17. The method of claim 14, further comprising sending a signal to a lower driver for exerting a force on a floor.

18. The method of claim 14, further comprising sending a signal to a driver for automatically adjusting or using a hand operated mechanism to adjust the wheel base of a base supporting the frame while the patient is being carried by the apparatus.

19. The method of claim 14, further comprising guiding the frame as the upper member is urged upward to reduce rotation of the frame.

20. A supine lift and stretcher apparatus for a patient, comprising:
a base portion at least partially defined by an elongated portion extending generally in a first orthogonal direction and having a first end, a second end, and a central portion interposed there between;
a frame having a first lateral portion extending in the first orthogonal direction and defining a first lateral portion distal end and a first lateral portion proximal end, a second lateral portion defining a second lateral portion distal end and a second lateral portion proximal end, a proximal portion interconnecting the first lateral portion proximal end and the second lateral portion proximal end, and a distal portion extending generally in a second orthogonal direction interconnecting the first lateral portion distal end and the second lateral portion distal end, wherein at least two of the first lateral portion, the second lateral portion, the proximal portion, and the distal portion define a frame opening;
an upper member having the first lateral portion at least partially interposed therein;
a lifting portion interconnecting the base with the upper member for moving the frame relative to the base generally in a third orthogonal direction;
a first axle portion having at least one wheel for transportation of the apparatus;
a second axle portion having at least one wheel for transportation of the apparatus;
a lower control portion including a driver and a lower floor contacting portion for exerting a force on a floor that the apparatus is supported on;
a control device for sending an electronic signal for raising and lowering the frame;
a sling portion having a plurality of strap portions for coupling the sling portion to the frame; and
a plurality of buckle portions attached to the frame for attaching a sling to the frame
wherein the first axle portion and the second axle portion are coupled to the base, wherein the frame is coupled to the lifting portion such that the frame may be rotated generally about an axis parallel to the first orthogonal direction and the lifting portion, wherein the lifting portion will selectively move the frame upward such that a patient in the sling will be raised above a surface, and wherein the first axle portion and the second axle portion may be moved relative to the base to increase and decrease a wheelbase including when the apparatus is being used to lift and to transport a patient.
